(19) United States
(12) Patent Application Publication
(10) Pub. No.: US 2026/0329335 A1
(43) Pub. Date: Oct. 22, 2026

(54) Modular Wearable Device System with NFC-Based Module Detection and Power Management

(71) Applicant: Karan Gabriel Pandey, Parkland, FL (US)

(72) Inventor: Karan Gabriel Pandey, Parkland, FL (US)

(21) Appl. No.: 19/040,963

(22) Filed: Jan. 30, 2025

(51) Int. Cl. G06F 1/16; G06F 3/01; G06F 3/041; G06F 3/147; G06F 3/16; H02J 50/10; H04B 5/77

(52) U.S. Cl. CPC G06F 1/163; G06F 3/011; G06F 3/147; G06F 3/041; G06F 3/167; H02J 50/10; H04B 5/77

(57) ABSTRACT

A wearable device system configured for attachment to a user's forearm, comprising a housing with a plurality of attachment interfaces on its upper surface. Each attachment interface includes magnetic coupling elements for securing external modules and power delivery mechanisms to supply power to the modules via inductive charging coils or conductive connectors. The housing contains a power source, a controller operatively connected to the power source, and near-field communication (NFC) readers associated with each attachment interface. The controller detects and identifies modules through NFC communication, dynamically adjusts power delivery, and manages module-specific operations. A display connected to the controller provides information related to system and module status, while a communication system enables data exchange with external devices. The system supports modularity through interchangeable external modules for diverse applications, ensuring flexibility and enhanced functionality. The controller implements efficient power management and safety protocols to optimize system operation.

### FIELD OF INVENTION

The present invention relates to wearable electronic devices, and more particularly, to a modular wearable system for forearm attachment that incorporates near-field communication (NFC) technology for module detection and management.

### BACKGROUND

In the development of wearable technology, several limitations inherent to existing devices have become apparent. The functionality of most wearable devices has traditionally been constrained to specific uses, such as fitness tracking or basic notifications. While these devices have integrated advanced features like GPS and heart rate monitoring, they often lack modularity and adaptability to meet the diverse and dynamic needs of modern users. The inability to seamlessly incorporate additional tools or expand their functionality through attachments highlights a fundamental design limitation. This rigidity restricts users to a predetermined set of features, leaving little room for personalization or enhanced utility.

Moreover, existing wearable devices typically fail to provide effective solutions for managing multiple personal gadgets and tools. The rise in the number of portable electronic devices has led to a corresponding increase in the demand for efficient charging and storage solutions. However, most wearables are limited to acting as accessory devices, relying on external equipment for power and offering no provisions for storing or attaching additional items. This limitation creates inefficiencies and adds to the complexity of managing personal devices, particularly in situations requiring mobility or minimalistic setups.

Another critical drawback of current systems is the lack of integrated control mechanisms for peripheral devices. While some wearables allow for limited interaction with other devices via Bluetooth or Wi-Fi, these systems often suffer from latency, lack of reliability, and restricted functionality. The absence of innovative technologies such as near-field communication (NFC) for precise identification and control of connected devices further limits their practical applications. This gap becomes even more pronounced in scenarios requiring the simultaneous management of multiple tools or functionalities.

Furthermore, the ergonomic and design aspects of wearable devices have often been neglected, resulting in products that fail to align with user preferences for comfort and ease of use. Traditional designs frequently compromise usability by focusing on aesthetics or specific niche functionalities rather than creating versatile systems that adapt to varying needs. The lack of a modular approach prevents these devices from serving as comprehensive platforms capable of accommodating diverse user requirements across industries, from healthcare to everyday consumer use.

These challenges underscore the need for a new approach to wearable technology, one that addresses the limitations of current systems while offering a versatile and user-centric solution. By identifying these deficiencies, the groundwork is laid for innovations that not only enhance functionality but also redefine the role of wearable devices in everyday life.

Prior art patent publication U.S. Pat. No. 9,693,609B2 describes a wearable device band with magnetic actuated attachment mechanisms, allowing secure and detachable connections through magnetic pins and apertures. The disclosure focuses on mechanical and magnetic coupling for ease of use and optional electrical connectivity via the magnetic interface. However, it fails to disclose the integration of near-field communication (NFC) technology for identifying and managing attached modules, as well as advanced power delivery systems such as inductive charging or dynamic controller-based module management.

Prior art patent publication US20200266975A1 discloses a wearable device incorporating RFID or NFC chipsets for secure communication and data encryption, with applications primarily focused on payment systems and identity verification. This disclosure emphasizes security features and communication protocols but does not address modular functionality, power delivery to attached devices, or the use of NFC to dynamically identify and manage multiple attachments in a wearable system.

Prior art patent publication US2024201031A1 relates to modular wearable interface devices comprising skin-conformable substrates and interchangeable functional modules. It describes a plug-and-play system with reconfigurable circuits for flexible configurations and various module types, such as sensors, actuators, and power sources. However, it does not disclose the use of NFC technology to detect and manage module attachments, nor does it include mechanisms for integrated power delivery at attachment interfaces, such as inductive charging or conductive connectors, to support diverse and complex modules.

It is within this context that the present invention is provided.

### SUMMARY

The present invention relates to a wearable device system configured for attachment to a user's forearm. The system includes a housing that provides a plurality of attachment interfaces on its upper surface. Each attachment interface incorporates magnetic coupling elements and power delivery mechanisms, enabling secure attachment and electrical connection with external modules. The housing contains a power source, a controller operatively connected to the power source, and a plurality of near-field communication (NFC) readers, each associated with one of the attachment interfaces. A display operatively connected to the controller presents information related to the operation of the system and any connected external modules. The system further includes a communication system for exchanging data with external modules and other devices.

The invention enables dynamic detection and management of external modules via the integration of NFC technology. The controller identifies and retrieves data from the NFC tags of connected modules, allowing it to configure power delivery, adjust system parameters, and display module-specific information on the display. This system facilitates modularity, flexibility, and enhanced functionality by supporting various interchangeable modules for diverse applications.

In some embodiments, the housing includes at least one adjustable strap composed of materials such as nylon, silicone, leather, or polymer. This feature ensures a secure and comfortable fit on the user's forearm, accommodating users of different sizes and preferences.

In further embodiments, the housing includes a comfort layer positioned between the housing and the user's forearm. This layer, made from materials such as hardened foam or polymer, reduces strain during extended use and enhances user comfort.

In yet further embodiments, the magnetic coupling elements comprise high-strength neodymium magnets arranged in geometric patterns such as squares or circles, providing reliable and detachable attachment for external modules. A steel backing plate may be included to enhance the strength of the magnetic connection.

In some embodiments, the power delivery mechanisms associated with each attachment interface include both inductive charging coils and conductive connectors. This dual configuration enables the system to accommodate a wide range of module power requirements, from wireless charging of small electronics to direct power transfer for higher-energy modules.

In further embodiments, the controller dynamically deactivates power delivery to an attachment interface when no module is detected via the associated NFC reader. This feature conserves energy and prevents unnecessary power consumption.

In yet further embodiments, the system includes Bluetooth connectivity within its communication system. This allows synchronization with external devices, such as smartphones, to exchange data and enable additional functionality, such as notifications and remote control.

In some embodiments, the display is a touchscreen configured to accept user inputs via gestures such as swipes, taps, and pinches. This provides an intuitive and efficient interface for controlling the system and its attached modules.

In further embodiments, the system includes a voice assistant integrated with the controller. The voice assistant allows users to issue voice commands for hands-free operation of the system and its connected modules.

In yet further embodiments, the system includes a modular expansion mechanism that allows multiple wearable device systems to be connected together. This enables users to combine systems for increased attachment capacity and coordinated operation between devices.

In some embodiments, the housing incorporates a dedicated magnetic charging pad on its upper surface, configured to charge external devices such as smartphones or wireless headphones. This enhances the utility of the wearable system by serving as a portable charging station.

In further embodiments, the controller implements safety protocols such as overcurrent protection, thermal management, and prioritization of essential functions. These features improve the reliability and durability of the system during operation.

In yet further embodiments, the NFC readers retrieve operational parameters from attached modules, such as identification data and power requirements, to dynamically adjust the system's operation. This enables seamless compatibility with a wide variety of external modules.

In some embodiments, the system's magnetic coupling elements are configured to maintain electrical contact with conductive connectors of external modules while allowing detachable operation. This ensures reliable power transfer while maintaining ease of use.

In further embodiments, the internal compartment of the housing contains a microcontroller configured to facilitate real-time data processing, module recognition, power management, and communication with the display and external devices. This centralized processing enhances the system's responsiveness and functionality.

### BRIEF DESCRIPTION OF THE DRAWINGS

Various embodiments of the invention are disclosed in the following detailed description and accompanying drawings.

FIG. 1 illustrates an example wearable gauntlet device system with visible exterior components, including a display, USB port, and attachment interfaces.

FIG. 2 illustrates an example wearable gauntlet device system with the top part of the housing removed to reveal internal components.

FIG. 3 illustrates an example wearable gauntlet device system with four attachments coupled to the top and a wireless connection to a smartphone.

FIG. 4 illustrates an example configuration of two wearable gauntlet device systems coupled together to encase a user's forearm, with attachments coupled to the upper gauntlet.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### DEFINITIONS

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

The use of spatial terms, such as “under,” “below,” “lower,” “over,” “upper,” etc., is used for ease of explanation to describe the relationship between elements when the apparatus is in its proper orientation.

The terms “first,” “second,” and the like are used to distinguish different elements or features, but these elements or features should not be limited by these terms. A first element or feature described can be referred to as a second element or feature and vice versa without departing from the teachings of the present disclosure.

The term “housing” refers to the structural component of the wearable device system that encases and protects internal components, such as the power source, controller, and NFC readers, while providing external attachment interfaces for modules. The housing may be constructed from lightweight, durable materials, including but not limited to aluminum alloys, titanium alloys, or reinforced polymer composites. In one example implementation, the housing may be formed from a titanium alloy with a brushed finish for durability and aesthetics, while incorporating polymer inserts to provide electrical insulation and enhanced shock absorption.

The term “attachment interface” refers to a region on the upper surface of the housing configured to secure external modules to the wearable device system. This includes magnetic coupling elements, power delivery mechanisms, and NFC readers for detecting and managing attached modules. In one example implementation, the attachment interface may include neodymium magnets arranged in a circular pattern with a steel backing plate to enhance the magnetic field, an inductive charging coil embedded beneath the surface for wireless power delivery, and a spring-loaded conductive connector to support modules requiring direct electrical contact.

The term “power source” refers to any component capable of supplying electrical power to the wearable device system and connected modules. This may include, but is not limited to, rechargeable lithium-ion batteries, solid-state batteries, or supercapacitors. In one example implementation, the power source may be a 3,000 mAh lithium-ion battery positioned within the internal compartment of the housing and rechargeable via a USB-C port located on the side of the device.

The term “controller” refers to a microcontroller or microprocessor that manages the operation of the wearable device system, including power distribution, NFC communication, and user interface interactions. The controller may be implemented using commercially available microcontrollers such as an ARM Cortex-M series processor or a comparable processing unit. In one example implementation, the controller may be an ARM Cortex-M4 microcontroller with integrated Bluetooth connectivity to enable seamless communication with external devices.

The term “near-field communication (NFC) reader” refers to a hardware component capable of wirelessly detecting and communicating with NFC tags associated with external modules. The NFC reader may be implemented as a discrete module or as part of an integrated circuit. In one example implementation, each attachment interface includes an NFC reader embedded beneath the surface of the housing, configured to operate at a frequency of 13.56 MHz and detect NFC tags within a range of 4 cm.

The term “magnetic coupling element” refers to a magnetic assembly integrated into the attachment interface to facilitate secure attachment of external modules. This includes high-strength magnets arranged in geometric configurations and optional steel backing plates to enhance the magnetic field. In one example implementation, the magnetic coupling element may include six neodymium magnets arranged in a hexagonal pattern with a central steel backing plate for improved stability and attachment strength.

The term “power delivery mechanism” refers to a component or combination of components configured to transfer electrical power from the power source to an external module secured to an attachment interface. This includes inductive charging coils for wireless power transfer and conductive connectors for direct electrical contact. In one example implementation, the power delivery mechanism may include a 10 W inductive charging coil and two spring-loaded conductive pins capable of delivering up to 5 V at 2 A.

The term “display” refers to any visual output device integrated into the wearable device system for presenting information to the user. This may include, but is not limited to, touchscreens, LED panels, or OLED displays. In one example implementation, the display may be a 2- inch OLED touchscreen with a resolution of 240×320 pixels, capable of providing real-time feedback on system status, module operations, and notifications from connected devices.

### DESCRIPTION OF DRAWINGS

The present invention relates to a modular wearable device system configured for attachment to a user's forearm, incorporating advanced features such as near-field communication (NFC) for module detection and management, magnetic coupling for secure attachment of external modules, and integrated power delivery mechanisms. The invention addresses several shortcomings of prior art systems by providing a highly adaptable and versatile platform capable of supporting a wide range of interchangeable modules, while also ensuring efficient power management, seamless integration with external devices, and user-friendly interaction.

Existing wearable devices, as described in the background, often lack the flexibility to adapt to diverse user needs. Many are limited to predefined functionalities and are unable to accommodate external modules or tools without significant hardware modifications. Moreover, prior art systems fail to integrate advanced technologies, such as NFC, for dynamically detecting and managing attached components. The present invention overcomes these limitations by incorporating modular attachment interfaces equipped with NFC readers, allowing the system to automatically identify and configure external modules in real-time. This enables users to easily switch between modules for different applications without manual reconfiguration or additional hardware.

Additionally, the invention resolves the challenges associated with power delivery in modular wearable systems. While prior art systems provide basic electrical connectivity or wireless charging, they often lack the versatility to support a range of power requirements for different modules. The present invention incorporates dual power delivery mechanisms, including inductive charging coils and conductive connectors, to accommodate modules with varying energy needs. This ensures reliable operation of both low-power devices, such as sensors, and higher-power tools, such as tasers or GPS units.

Another significant advancement offered by the present invention is its robust user interface and system management capabilities. The integrated controller dynamically manages power distribution, module recognition, and user interaction, providing an intuitive and efficient operating experience. The controller also implements safety protocols, such as overcurrent protection and thermal management, which enhance the reliability and durability of the system during operation. These features, combined with a high-resolution touchscreen display and optional voice assistant, ensure that the invention provides a seamless and interactive user experience.

In addressing the shortcomings of prior art systems, the present invention offers a comprehensive solution for modular wearable technology. It provides users with a platform that is adaptable, efficient, and capable of supporting a diverse ecosystem of external modules. These advantages make the invention suitable for a wide range of applications, from everyday consumer use to specialized industries such as healthcare, defense, and emergency services.

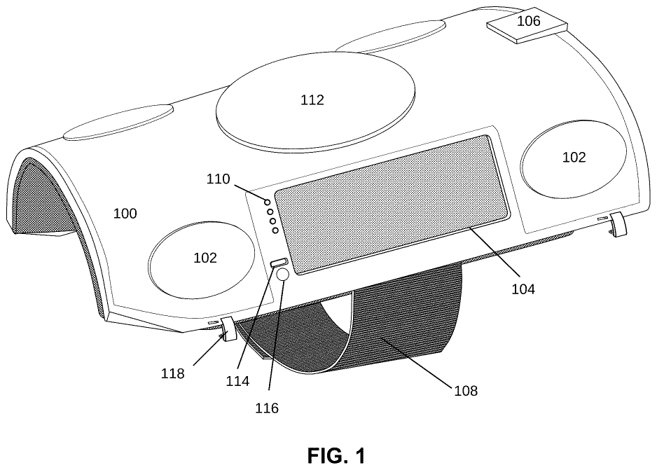

FIG. 1 illustrates an isometric perspective view of an example wearable gauntlet device system. The gauntlet includes a housing 100 configured to be secured to a user's forearm. The housing 100 is shown with a generally elongated structure that conforms to the shape of the forearm, with an upper surface defining a plurality of attachment interfaces 102 positioned in strategic locations to allow for the modular attachment of external devices. These attachment interfaces 102 are depicted as recessed or flush areas with visible magnetic coupling elements embedded beneath their surfaces. The attachment interfaces 102 may include magnets arranged in a geometric configuration, such as a square or circular arrangement, and may also house power delivery mechanisms, such as inductive charging coils or conductive connectors, which are not directly visible in this figure.

On the upper surface of the housing 100, a display 104 is shown prominently positioned near the center of the gauntlet. The display 104 is depicted as a rectangular touchscreen with rounded edges, though it may take other shapes, such as circular or irregular polygons, depending on the implementation. The display 104 is configured to provide a user interface for interacting with the gauntlet, displaying information such as notifications, module status, or navigation data. The touchscreen may accept user inputs through touch gestures or a stylus, and in some embodiments, it may integrate additional input methods such as haptic feedback or gesture recognition.

Visible near the rear edge of the housing 100 is a USB port 106, which provides access for charging the internal power source or connecting external devices. The USB port 106 is shown as a standard USB-C connector in this embodiment but may alternatively utilize other port types, such as micro-USB or proprietary connectors, depending on design preferences or application requirements. The port 106 is positioned to maintain accessibility while minimizing interference with the operation of other features on the gauntlet.

The housing 100 is supported by an adjustable strap 108, which is partially visible beneath the gauntlet in this view. The strap 108 is depicted as a wide, ergonomic band made from a durable and flexible material, such as nylon, silicone, or a composite polymer. The strap 108 may include features such as a buckle, Velcro, or a combination of fastening mechanisms to ensure a secure and customizable fit. In some embodiments, the strap 108 may be detachable or interchangeable, allowing users to select different materials, colors, or designs for personalization or specific use cases.

The upper surface of the housing 100 further includes LED indicators 110, positioned adjacent to the display 104. These indicators may provide visual feedback on system status, such as power levels, notifications, or the operational state of attached modules. The LED indicators 110 may take the form of discrete lights or integrated light strips and may emit different colors or flashing patterns based on the information being conveyed.

A magnetic charging pad 112 is also shown on the upper surface of the housing 100, positioned near the rear of the gauntlet. The magnetic charging pad 112 provides a dedicated surface for charging external devices, such as smartphones, headphones, or other wearable electronics. The charging pad 112 may feature a smooth or slightly recessed surface to ensure proper alignment of devices during charging.

For systems with voice assistant integration, a microphone 114 and speaker 116 are visible on the housing 100. The microphone 114 is positioned near the display 104, while the speaker 116 is located along the side of the housing. These components facilitate voice command input and audio output, enabling hands-free interaction with the system and connected devices. The microphone 114 may include noise-canceling capabilities to improve voice recognition accuracy, and the speaker 116 may support high-quality audio output for notifications or communication.

Along the edges of the housing 100, inter-gauntlet connection mechanisms 118 are visible. These mechanisms allow multiple gauntlets to be physically and electrically connected to expand the system's functionality. The inter-gauntlet connection mechanisms 118 may include magnetic clasps, mechanical locking points, or conductive pads to facilitate secure coupling and coordinated operation between devices.

The exterior surface of the housing 100 is smooth and contoured, designed for comfort during extended wear. The material of the housing 100 may include lightweight and durable options such as aluminum, titanium, or reinforced polymers. The exterior may also feature protective coatings for water resistance, scratch resistance, or enhanced aesthetics.

Although not visible in this figure, the attachment interfaces 102 are equipped with NFC readers embedded beneath the surface. These NFC readers are configured to detect and identify external modules attached to the interfaces, enabling dynamic configuration of the gauntlet. Modules such as flashlights, health monitors, or GPS units may be attached to the interfaces 102 and secured through the magnetic coupling elements, which are shown as flush or recessed features for streamlined aesthetics.

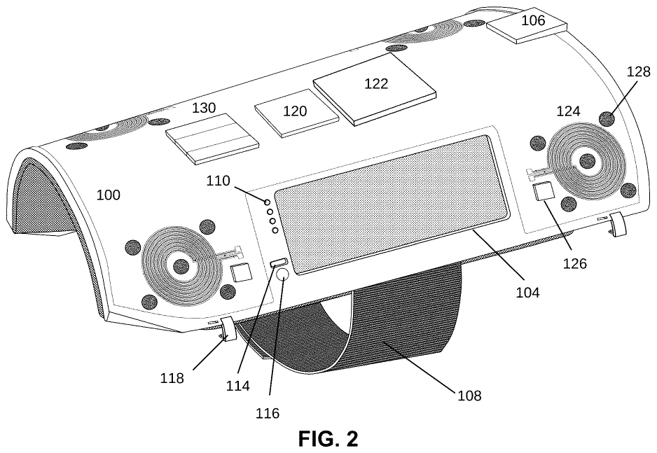

FIG. 2 illustrates the same wearable gauntlet device system with the top part of the housing 100 removed to reveal the internal components. This view demonstrates the arrangement of the internal mechanisms that enable the modular and functional design of the device.

At the center of the internal compartment is the controller 120, a microcontroller or processing unit responsible for managing the overall operation of the wearable device system. The controller 120 is connected to and communicates with the various components within the housing, coordinating functions such as power management, module detection, and user interface control. The controller 120 is shown as a compact circuit board securely mounted within the housing, with wiring extending to peripheral components.

Adjacent to the controller 120 is the power source 122, a rechargeable battery that supplies power to the entire system, including the display 104, attachment interfaces 102, and any connected modules. The power source 122 is shown in a rectangular configuration, positioned near the rear of the housing to optimize weight distribution and ensure comfort during use. The power source 122 is electrically connected to the controller 120 and other components via a wiring harness, enabling efficient energy transfer.

Positioned beneath each attachment interface 102 are the NFC readers 124, which are responsible for detecting and communicating with NFC tags on external modules. The NFC readers 124 are embedded beneath the surface of the attachment interfaces and shown as small, flat modules connected to the controller 120. These readers facilitate dynamic module identification and configuration by wirelessly retrieving operational data from attached modules.

Associated with the attachment interfaces 102 are the power delivery mechanisms 126, which enable the system to supply electrical power to connected modules. The power delivery mechanisms 126 include inductive charging coils, shown as circular or spiral structures, for wireless power transfer, as well as conductive connectors, depicted as small spring-loaded pins, for direct electrical contact. The power delivery mechanisms 126 are connected to the power source 122 and controlled by the controller 120 to ensure proper power delivery based on module requirements.

Also visible beneath the attachment interfaces 102 are the magnetic coupling elements 128, comprising high-strength magnets arranged in geometric patterns, such as circular or square configurations. These magnets are paired with steel backing plates to enhance magnetic strength, ensuring secure attachment of external modules to the interfaces. The magnetic coupling elements 128 are seamlessly integrated with the attachment interfaces 102 to maintain a streamlined design.

Near the controller 120 are the communication modules 130, which enable wireless data exchange with external devices via Bluetooth, Wi-Fi, or other protocols. The communication modules 130 are shown as integrated components on the circuit board of the controller 120, allowing the system to synchronize with smartphones, IoT devices, and other peripherals.

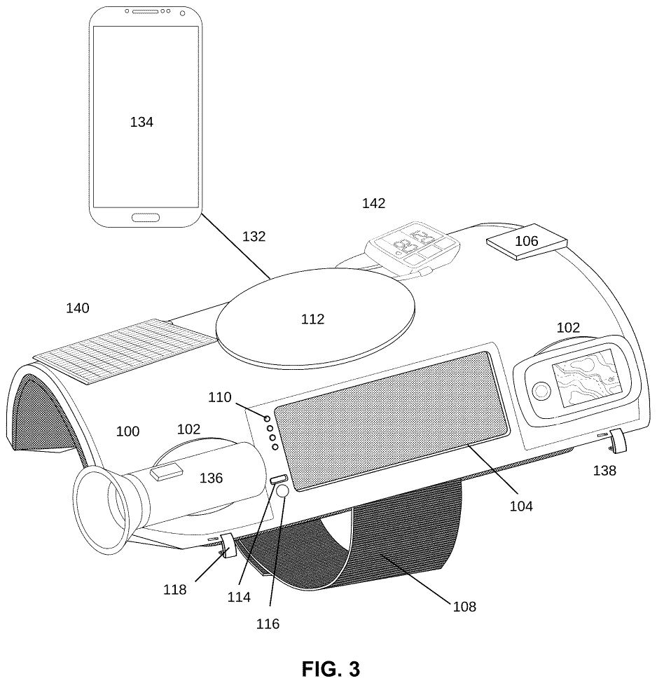

FIG. 3 illustrates an isometric perspective view of the wearable gauntlet device system, similar to FIG. 1, but with four attachments coupled to the attachment interfaces 102 on the top surface of the gauntlet. Additionally, a wireless connection 132 to an external device 134, such as a smartphone, is depicted. The attachments shown in this figure include a flashlight 136, a GPS module 138, a solar charging panel 140, and a health monitoring sensor 142. These attachments are shown for illustrative purposes, and it should be understood that the system is capable of supporting a wide variety of interchangeable modules, as detailed below.

The flashlight 136 is shown as an external module secured to one of the attachment interfaces 102 via magnetic coupling elements 128. It receives power from the power delivery mechanism 126, which can be configured for inductive or direct charging depending on the attachment's requirements. The flashlight 136 may also be controlled through the integrated touchscreen display 104, with options to adjust brightness, activate strobe functions, or display battery levels.

The GPS module 138 is another example of an attached module, providing navigation capabilities to the system. The GPS module 138 communicates with the controller 120 via the NFC reader 124 associated with its attachment interface 102. Upon connection, the NFC reader 124 identifies the module and relays its operational data to the controller 120, which updates the display 104 to show navigation options, location data, and routing preferences. The module may also synchronize with external apps on the paired smartphone via the communication module 130.

The solar charging panel 140 is depicted as an attachment designed to supplement the power source 122 by converting solar energy into electrical power. Once attached, the NFC reader 124 detects the module, and the controller 120 adjusts the system to prioritize charging the internal power source 122 or powering other connected modules directly from the panel's output. The display 104 may show real-time power generation data, allowing the user to monitor its performance.

The health monitoring sensor 142 is shown attached to one of the interfaces 102, configured to measure vital signs such as heart rate, blood oxygen levels, or stress metrics. The sensor transmits its data to the controller 120 via NFC, where it is processed and displayed on the touchscreen 104. The health data may also be synced to a fitness tracking app on the connected smartphone through the communication module 130.

While FIG. 3 shows the flashlight 136, GPS module 138, solar charging panel 140, and health monitoring sensor 142, it should be noted that the wearable device system can accommodate a broad range of additional attachments. These include, but are not limited to, tasers, pepper spray modules, expandable storage drives, projectors, cameras, AirPod holders, multi-tools, flamethrowers/torches, digital keys for locking/unlocking doors, card wallets, pens, mini notebooks, and digital wallet systems for payments or ticketing. Each attachment is designed to interface seamlessly with the gauntlet via the attachment interfaces 102 and is managed dynamically by the controller 120.

The controller 120 plays a central role in managing the operations of the device. For the integrated apps accessible through the touchscreen display 104, the controller 120 provides a user-friendly interface for real-time interactions. These apps may include navigation tools, health and fitness tracking dashboards, notification management systems, media controls, and system status monitors. The controller 120 processes data from connected modules and integrates it into these apps, ensuring that users can control and monitor their attachments directly from the display.

For example, when a GPS module 138 is attached, the controller 120 retrieves navigation data and displays real-time maps and directions on the touchscreen 104. If a health monitoring sensor 142 is connected, the controller 120 processes biometric data and provides visual graphs or notifications for heart rate and stress levels. Similarly, when a flashlight 136 is connected, the controller 120 allows the user to toggle brightness levels or activate strobe modes through the touchscreen.

For apps on wireless external devices, such as a paired smartphone, the controller 120 utilizes the communication module 130 to establish a data link. This connection allows the wearable system to mirror notifications, sync health data, or interact with third-party apps. For instance, the health monitoring sensor 142 may transmit data to a fitness tracking app on the smartphone, while the GPS module 138 may synchronize location data for mapping apps. Notifications received on the smartphone, such as calls, texts, or app alerts, are relayed to the display 104, enabling the user to manage them directly from the gauntlet.

In scenarios where multiple attachments are connected simultaneously, the controller 120 coordinates their operations by allocating power from the power source 122, prioritizing critical modules, and displaying their individual statuses on the touchscreen 104. If an attachment is removed, the controller 120 resets the corresponding attachment interface 102 and adjusts the system configuration accordingly.

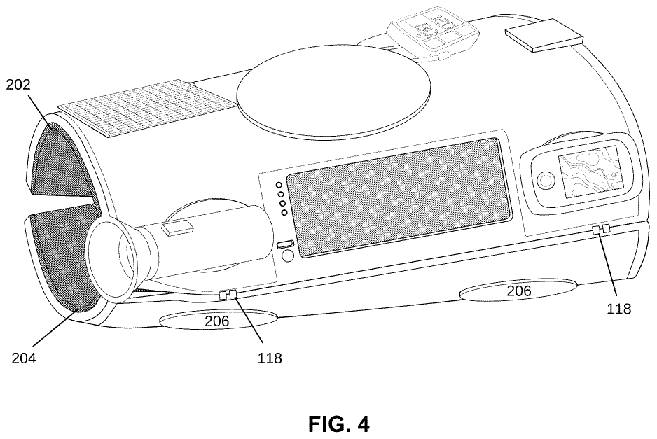

FIG. 4 illustrates an isometric perspective view of two wearable gauntlet device systems coupled together to encase the user's forearm entirely. The upper gauntlet 202, positioned on the dorsal side of the forearm, is shown with four attachments—similar to those described in FIG. 3—coupled to its attachment interfaces 102. The lower gauntlet 204, positioned on the ventral side of the forearm, is depicted with its attachment interfaces 206 visible and available to receive additional external modules.

The inter-gauntlet connection mechanisms 118 are shown along the edges of the upper and lower gauntlets, allowing them to be securely attached to one another. These mechanisms may include magnetic clasps, mechanical locking points, or conductive pads to facilitate physical and electrical coupling between the two devices. When coupled, the two gauntlets operate in coordination via the controllers within each housing, communicating through inter-gauntlet wiring or wireless protocols enabled by the communication modules.

The upper gauntlet 202 retains its modular functionality, with its attachments being dynamically managed by its controller. The lower gauntlet 204, while currently unoccupied by attachments in FIG. 4, provides additional capacity for modules, effectively expanding the system's utility. This configuration allows users to operate up to eight attachments simultaneously, with the controllers of the two gauntlets synchronizing their operations to allocate power and manage data efficiently.

The design shown in FIG. 4 highlights the adaptability of the system, accommodating users with enhanced requirements for module capacity and functionality. The coupling of the two gauntlets ensures that all attachment interfaces remain fully operational, while the ergonomic design of the housing and straps ensures a secure and comfortable fit for the user. While the figure shows one example configuration, alternative arrangements and interconnection methods are possible without departing from the scope of the invention.

### CONTROLLER/PROCESSOR COMPONENTS

A processor or controller as described herein may include any suitable type of computing device, such as a central processing unit (CPU), microcontroller, graphics processing unit (GPU), system on a chip (SoC), or digital signal processor (DSP). It may operate with one or more cores and may be configured to execute the functions described in this disclosure.

The processor may be operably connected to one or more memory devices, such as random access memory (RAM), read-only memory (ROM), flash storage, or solid-state drives (SSD). These memory devices store computer-readable instructions that, when executed by the processor, perform the methods described. The processor and memory communicate via data buses or other suitable communication pathways.

The computing device may also include input/output (I/O) devices, such as a touchscreen, mouse, keyboard, display, or speaker, to facilitate interaction with users or other systems. Additionally, it may include a network interface, such as a wired or wireless communication module, for connecting to networks.

Control logic or software instructions may be stored in memory and executed by the processor to implement specific functionalities. This logic may be modular, consisting of software components, processes, or functions that work together to perform the operations described herein.

The described computing operations involve the manipulation of data represented as electrical, optical, or magnetic signals stored or transferred within the system. These operations are machine-executed and do not require manual intervention, though they may interface with human operators through appropriate user interfaces.

The systems and methods described are not limited to any particular hardware configuration or programming language and may be implemented on general-purpose or specialized computing devices.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the wearable device system of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A wearable device system, comprising:
a housing configured to be secured to a user's forearm, the housing including:
an upper surface defining a plurality of attachment interfaces;
an internal compartment containing:
a power source;
a controller operatively connected to the power source;
a plurality of communication modules including a near-field communication (NFC) reader associated with each of the plurality of attachment interfaces;
a plurality of magnetic coupling elements integrated into the attachment interfaces, each magnetic coupling element being configured to removably secure an external module to the attachment interface;
a power delivery mechanism associated with each attachment interface, the power delivery mechanism configured to deliver electrical power from the power source to an external module secured to the attachment interface, the power delivery mechanism comprising at least one of:
an inductive charging coil positioned within the attachment interface; or
a set of conductive connectors exposed at the attachment interface;
a display operatively connected to the controller, the display configured to present information based on inputs received from the controller; and
a communication system configured to exchange data between the controller and one or more external modules secured to the attachment interfaces, wherein the controller is configured to:
identify an external module secured to one of the attachment interfaces by reading data from an NFC tag associated with the external module via the corresponding NFC reader; and
adjust at least one operational parameter of the wearable device system based on the data received from the NFC tag.

2. The wearable device system of claim 1, wherein the housing further includes at least one adjustable strap configured to secure the housing to the user's forearm, the strap being composed of a material selected from the group consisting of nylon, silicone, leather, or a polymer material.

3. The wearable device system of claim 1, wherein the housing further includes a comfort layer positioned between the housing and the user's forearm, the comfort layer being made of a material selected from the group consisting of hardened foam, polymer, fabric, or leather.

4. The wearable device system of claim 1, wherein each magnetic coupling element includes a plurality of high-strength neodymium magnets arranged in a geometric configuration selected from a square or circular pattern.

5. The wearable device system of claim 1, wherein each magnetic coupling element further comprises a steel backing plate to enhance the magnetic field strength for attachment stability.

6. The wearable device system of claim 1, wherein the power source comprises a rechargeable battery located within the internal compartment, the battery being operatively connected to a USB-C charging port accessible from the exterior of the housing.

7. The wearable device system of claim 1, wherein each attachment interface is configured to support both an inductive charging coil and conductive connectors, wherein the controller selects one of the power delivery mechanisms based on the requirements of the external module.

8. The wearable device system of claim 1, wherein the controller is further configured to deactivate power delivery to an attachment interface when no external module is detected by the NFC reader associated with the interface.

9. The wearable device system of claim 1, wherein the communication system includes Bluetooth connectivity for exchanging data with external devices, enabling synchronization with smartphones or other wireless-enabled devices.

10. The wearable device system of claim 1, further comprising an app ecosystem hosted on the display, the ecosystem being configured to provide user interfaces for health monitoring, navigation, notifications, and control of external modules.

11. The wearable device system of claim 1, wherein the display is a touchscreen configured to accept user input via touch gestures, including swipes, taps, and pinches, for controlling functions of the wearable device system.

12. The wearable device system of claim 1, further comprising a voice assistant integrated with the controller, wherein the voice assistant is configured to accept and process voice commands to control the wearable device system and connected modules.

13. The wearable device system of claim 1, wherein the controller is configured to display operational parameters of the external modules on the display, including power levels, module-specific settings, and notifications received from a connected device.

14. The wearable device system of claim 1, further comprising a modular expansion mechanism configured to connect multiple wearable device systems together, wherein the systems communicate via Bluetooth or NFC for synchronized operation.

15. The wearable device system of claim 1, wherein the housing includes a dedicated magnetic charging pad positioned on the upper surface, the charging pad being configured to charge external devices such as smartphones, headphones, or wearable electronics.

16. The wearable device system of claim 1, wherein each attachment interface is configured to accommodate interchangeable external modules, including but not limited to flashlights, tasers, GPS units, health monitors, solar charging panels, or storage devices.

17. The wearable device system of claim 1, wherein the controller is further configured to implement safety protocols, including overcurrent protection, thermal management, and power supply prioritization for essential functions.

18. The wearable device system of claim 1, wherein the NFC reader is configured to retrieve operational parameters from the NFC tag of an external module, including identification data, power requirements, and module-specific configuration data.

19. The wearable device system of claim 1, wherein the magnetic coupling elements are configured to maintain electrical contact with conductive connectors of external modules while allowing detachable operation through magnetic retention.

20. The wearable device system of claim 1, wherein the internal compartment further includes a microcontroller configured to facilitate real-time data processing, module recognition, power management, and communication with the display and external devices.
